(19) United States
(12) Patent Application Publication
(10) Pub. No.: US 2009/0312444 A1
(43) Pub. Date: Dec. 17, 2009

(54) CAST MOLDED ARTICLE MADE OF POLYURETHANE POROUS SUBSTANCE AND METHOD FOR PRODUCING THE SAME

(75) Inventors: Katsuji Shinohara, Osaka (JP); Kazuo Takemoto, Osaka (JP); Hitomi Ninomiya, Osaka (JP); Motoyoshi Hosokawa, Osaka (JP); Chihiro Tani, Osaka (JP)

Correspondence Address: VEDDER PRICE P.C., 222 N. LASALLE STREET, CHICAGO, IL, 60601, US

(73) Assignee: TOYO POLYMER CO., LTD., Osaka (JP)

(21) Appl. No.: 12/350,046

(22) Filed: Jan. 7, 2009

(30) Foreign Application Priority Data
Jun. 16, 2008 (JP) 2008-157001
Oct. 7, 2008 (JP) 2008-260501

(51) Int. Cl. C08J 9/228; C08G 18/32

(52) U.S. Cl. 521/80; 521/170

(57) ABSTRACT

An object of the invention is, in producing a cast molded article by crosslinking a water-dispersed urethane prepolymer with a polyamine compound, providing a method for producing a cast molded article made of a polyurethane porous substance in which a cured reactant has good demolding properties and a cast molded article with a fine structure can be easily produced, and a cast molded article having a fine structure with high dimensional accuracy. The cast molded article of this invention is produced by reacting polyol, a chain length regulator, isocyanate and 0.1 through 4 wt % of a hydrophilic chain length regulator to one another, allowing a resultant urethane prepolymer having a terminal isocyanate group to be mixed with and dispersed in water, mixing a resultant water-dispersed urethane prepolymer with 1,4-diaminobutane and injecting a resultant mixture into a die for crosslinkage, and demolding a resultant cured reactant and removing moisture from the cured reactant.

### BACKGROUND OF THE INVENTION

1. Field of the Invention

The present invention relates to a cast molded article made of a polyurethane porous substance and a method for producing the same.

2. Description of the Related Art

A polyurethane porous substance having fine interconnected pores is conventionally produced by reacting, for example, a urethane emulsion with water-soluble polyisocyanate used as a primary crosslinking agent and a polyamine compound used as a secondary crosslinking agent as represented in Japanese Patent Application No. 2003-48940.

If a polyurethane porous substance can be produced from an emulsion of a urethane prepolymer by using a polyamine compound alone as a crosslinking agent, the number of used components can be reduced, and this is very useful from the standpoint of production costs.

In order to overcome such a technical problem, Japanese Patent Application No. 2005-126670, describes the following: In causing cross-linkage, with a polyamine compound, of a water-dispersed urethane prepolymer having a terminal isocyanate group obtained by polymerizing polyol, a chain length regulator, a hydrophilic chain length regulator and an isocyanate group, when the content of the hydrophilic chain length regulator is set within a specific range in reaction components of the urethane prepolymer, a cast molded article having useful properties as a water-absorbing roll, an OA equipment roll, a water-absorbing member, a printing face member or the like can be produced.

The present inventors have found, however, the following through examination: When a cast molded article with a fine structure is to be produced on the basis of the technique described in Japanese Patent Application No. 2005-126670, it is sometimes difficult to demold a cured reactant due to faulty curing or it is sometimes impossible to produce a molded article with high dimensional accuracy.

Accordingly, a principal object of the invention is, in producing a cast molded article by crosslinking a water-dispersed urethane prepolymer with a polyamine compound, providing a method for producing a cast molded article made of a polyurethane porous substance in which a cured reactant has good demolding properties and a cast molded article with a fine structure can be easily produced, and a cast molded article having a fine structure with high dimensional accuracy.

### SUMMARY OF THE INVENTION

The present inventors have found that the aforementioned problems can be overcome by using 1,4-diaminobutane as a curing agent, resulting in achieving the present invention.

Specifically, the present invention covers the following:

[1] A cast molded article made of a polyurethane porous substance obtained by removing moisture from a cured reactant resulting from crosslinking a water-dispersed urethane prepolymer having a terminal isocyanate group, which is obtained by reacting polyol, a chain length regulator, isocyanate and 0.1 through 4 wt % of a hydrophilic chain length regulator to one another, with 1,4-diaminobutane within a die;

[2] an artificial limb related tool made of the polyurethane porous substance described in item [1];

[3] a method for producing a cast molded article made of a polyurethane porous substance including the steps of reacting polyol, a chain length regulator, isocyanate and 0.1 through 4 wt % of a hydrophilic chain length regulator to one another, whereby obtaining a urethane prepolymer having a terminal isocyanate group, allowing the urethane prepolymer having a terminal isocyanate group to be mixed with and dispersed in water, whereby obtaining a water-dispersed urethane prepolymer, mixing the water-dispersed urethane prepolymer with 1,4-diaminobutane and injecting a resultant mixture into a die for crosslinkage, whereby obtaining a cured reactant, and demolding the cured reactant and removing moisture from the cured reactant;

[4] a method for producing a cast molded article described in item [3] in which the step of mixing the water-dispersed urethane prepolymer with 1,4-diaminobutane and injecting a resultant mixture into a die for crosslinkage includes a sub-step of applying pressure after injecting the mixture into the die; and

[5] a method for producing a cast molded article described in item [3] or [4] in which the die is a die for producing an artificial limb related tool.

According to item [1], the invention provides a cast molded article, which is obtained by crosslinking a water-dispersed urethane prepolymer with a polyamine compound, having a fine structure with high dimensional accuracy.

According to item [2], the invention provides an artificial limb related tool that is light and breathable as compared with a silicone artificial limb related tool.

According to item [3], for producing a cast molded article by crosslinking a water-dispersed urethane prepolymer with a polyamine compound, a cast molded article that is obtained from a cured reactant with good demolding properties and has a fine structure can be easily produced.

According to item [4], a cast molded article with high surface accuracy can be produced by reducing the size of bubbles formed during the crosslinkage.

According to item [5], an artificial limb related tool that is light and breathable as compared with a silicone artificial limb related tool can be produced.

### BRIEF DESCRIPTION OF THE DRAWINGS

FIG. 1 is a perspective outline view showing an example of a cast molded article in the shape of a human hand.

FIG. 2 is a perspective outline view showing an example of a cast molded article in the shape of a brush.

FIG. 3 is a perspective outline view showing an example of a cast molded article in the shape of a foot massage tool.

### DETAILED DESCRIPTION OF THE PREFERRED EMBODIMENTS

A cast molded article made of a polyurethane porous substance of this invention is obtained by mixing a water-dispersed urethane prepolymer, that is, a urethane prepolymer dispersed in water, with 1,4-diaminobutane, and crosslinking the thus obtained mixture within a die. Furthermore, the urethane prepolymer herein is obtained by polymerizing polyol, a chain length regulator, isocyanate and a hydrophilic chain length regulator as essential elements and has a terminal isocyanate group.

The polyol is not particularly specified as long as it is used for general production of polyurethane and has two or more hydroxyl groups in a molecule, and examples are polyether polyol, polyester polyol, polycarbonate polyol, polylactone polyol, polyolefin polyol, acrylic-based polyol, ricinus oil-based polyol and silicone-based polyol, and one of them or a mixture of two or more of them can be used. Among these examples, from the standpoint of suppressing degradation of the molded article to be produced, polycarbonate polyol is preferably used. The degradation herein includes degradation with light, degradation with water and the like.

An example of the polyether polyol is one obtained by polymerizing or copolymerizing alkylene oxide (such as ethylene oxide, propylene oxide or butylene oxide) and/or heterocyclic ether (such as tetrahydrofuran), and specific examples are polyethylene glycol, polypropylene glycol, (block or random) polyethylene-polypropylene glycol, (block or random) polyethylene-tetramethylene glycol, polytetramethylene glycol, poly-2-methyltetramethylene glycol and polyhexamethylene glycol. Another example is amine-based ether polyol obtained by adding alkylene oxide (such as ethylene oxide, propylene oxide or butylene oxide) to an amine compound (such as mono- or diamine, hydrazine or substituted hydrazine).

An example of the polyester polyol is one obtained by condensation polymerizing aliphatic dicarboxylic acid (such as succinic acid, adipic acid, sebacic acid, glutaric acid or azelaic acid) and/or aromatic dicarboxylic acid (such as isophthalic acid or terephthalic acid) and low molecular glycol (such as ethylene glycol, propylene glycol, 1,4-butanediol, 1,6-hexanediol, 3-methyl-1,5-pentanediol, neopentyl glycol or 1,4-dihydroxymethylcyclohexane), and specific examples are polyethylene glycol adipate, polybutanediol adipate, polyhexanediol adipate, poly-3-methylpentanediol adipate, polyneopentyl glycol adipate, polyethylene/butylene adipate diol, polyneopentyl/hexyl adipate diol and polybutylene isophthalate diol.

Examples of the polycarbonate polyol are polybutanediol carbonate, poly-3-methylpentanediol carbonate, polyhexanediol carbonate, polynonanediol carbonate, polybutanediol hexanediol carbonate, polypentanediol hexanediol carbonate, poly-2-methyloctanediol nonanediol carbonate and poly-3-methylpentanediol hexanediol carbonate.

Examples of the polylactone polyol are polycaprolactonediol, polycaprolactonetriol and poly-3-methylvalerolactonediol.

Examples of the polyolefin polyol are polybutadiene glycol, polyisoprene glycol and a hydride thereof.

The silicone-based polyol is one having a hydroxyl group introduced into a polysiloxane principal chain. Also, the introduced hydroxyl group may be disposed at both or one of the ends of the polysiloxane principal chain.

From the standpoint of forming fine interconnected pores in the molded article to be produced, the number average molecular weight of the polyol is preferably 500 through 5000, more preferably 500 through 4000 and most preferably 500 through 3000.

The chain length regulator is not particularly specified as long as it is a short-chain diol compound used in general production of polyurethane and having two or more hydroxyl groups in a molecule, and examples are ethylene glycol, diethylene glycol, propylene glycol, dipropylene glycol, 1,3-butanediol, 1,4-butanediol, 1,5-pentanediol, 1,6-hexanediol, neopentyl glycol, 3-methylpentanediol, nonanediol, octanediol, dimethylolheptane and 1,4-cyclohexanediol, and one of them or a mixture of two or more of them can be used.

From the standpoint of obtaining a molded article with good product characteristics, the content of the chain length regulator is preferably 0.1 through 10 parts by weight, more preferably 0.5 through 7 parts by weight and most preferably 1 through 5 parts by weight based on 100 parts by weight of the polyol.

The isocyanate is not particularly specified as long as it is used in general production of polyurethane and has two or more isocyanate groups at ends, and examples are aromatic polyisocyanate and a hydrogenated substance thereof such as 2,4-toluene diisocyanate, 2,6-toluene diisocyanate, 4,4′-diphenylmethane diisocyanate, 3,3′-dichloro-4,4′-diphenylmethane diisocyanate, 2,2′-diphenylmethane diisocyanate, 2,4′-diphenylmethane diisocyanate, crude diphenylmethane isocyanate, xylylene diisocyanate, phenylene diisocyanate, 1,5-naphthalene diisocyanate, hydrogenated diphenylmethane diisocyanate or hydrogenated xylylene diisocyanate; alicyclic polyisocyanate such as 1,4-cyclohexane diisocyanate, isophorone diisocyanate or norbornane diisocyanate; and aliphatic polyisocyanate such as tetramethylene diisocyanate or 1,6-hexamethylene diisocyanate, and one of them or a mixture of two or more of them can be used.

The content of the isocyanate is not particularly specified as long as the resultant urethane prepolymer has an isocyanate group at the end thereof, and the isocyanate is included in a content for quantitatively reacting with active hydrogen groups of the polyol, the chain length regulator and the hydrophilic chain length regulator described below.

Examples of the hydrophilic chain length regulator are an anionic chain length regulator having one or more anionic hydrophilic groups (such as a carboxyl group or a sulfone group) within a molecule, such as a polyhydroxy compound, a nonionic chain length regulator such as an ethylene oxide compound, a cationic chain length regulator such as N-methyldiethanolamine, and one of them or a mixture of two or more of them can be used. Among these examples, the anionic chain length regulator is preferably used, and specific examples of the anionic chain length regulator are 2,2-dimethylollactic acid, 2,2-dimethylolpropionic acid, 2,2-dimethylolbutanoic acid, 2,2-dimethylolbutyric acid, 2,2-dimethylolvaleric acid and 1,4-butanediol-2-sulfonic acid, and one of them or a mixture of two or more of them can be used.

The content of the hydrophilic chain length regulator depends upon the kinds of the polyol and the isocyanate used together, and from the standpoint of improving water dispersibility of the resultant urethane prepolymer and a curing property described below and obtaining a molded article having fine interconnected pores, the content is preferably 0.1 through 4 wt %, more preferably 1 through 4 wt % and most preferably 1 through 3 wt % in all the reaction components included in the urethane prepolymer. When the content of the hydrophilic chain length regulator is smaller than 0.1 wt %, there is concern that the water dispersibility of the resultant urethane prepolymer may be extremely low. On the other hand, when the content of the hydrophilic chain length regulator exceeds 4 wt %, there is concern that the curing property of the resultant water-dispersed urethane prepolymer may be spoiled. Herein, the “reaction components included in the urethane prepolymer” mean essential materials used for producing the urethane prepolymer and specifically correspond to the polyol, the chain length regulator, the isocyanate and the hydrophilic chain length regulator.

The urethane prepolymer can be produced by any of the known methods, which are not particularly specified. For example, in the presence or absence of an organic solvent not including an active hydrogen group within a molecule, the polyol, the chain length regulator, the hydrophilic chain length regulator and the isocyanate are reacted with one another by a one-shot method or a multistage method at preferably 20 through 150° C. and more preferably 60 through 120° C. for 2 through 10 hours. At this point, the order of adding the essential components is not specified. Also, the end point of the reaction is preferably controlled in accordance with the viscosity and the terminal NCO %.

The organic solvent is used for lowering the viscosity in producing the urethane prepolymer, and examples are acetone, methyl ethyl ketone, N-methylpyrolidone, toluene, tetrahydrofuran, dioxane and N,N′-dimethylformamide.

The water-dispersed urethane prepolymer of this invention is obtained by dispersing the urethane prepolymer in water, and the content of the urethane prepolymer based on the water (hereinafter sometimes referred to as a “solid content concentration”) is preferably 30 through 70 wt % and more preferably 35 through 60 wt % from the standpoint of securing the strength of the molded article to be produced.

The method for preparing the water-dispersed urethane prepolymer is not particularly specified, and for example, the urethane prepolymer is mixed to be dispersed in water at room temperature (20 through 40° C.) by using a dispersing apparatus such as a dispersion mixer, a homomixer or a homogenizer.

At this point, when an anionic chain length regulator is used as the hydrophilic chain length regulator, an anionic hydrophilic group of the hydrophilic chain length regulator included in the urethane prepolymer may be neutralized beforehand for improving the water dispersibility of the urethane prepolymer. Examples of a neutralizing agent used in this case are lower alkylamine such as trimethylamine, triethylamine, tri-n-propylamine or tri-n-butylamine; and an inorganic neutralizing agent such as ammonia. Among these examples, trimethylamine or triethylamine having a boiling point lower than water is preferably used because it can be easily removed in a moisture removing process described below.

The content of the neutralizing agent is not particularly specified and, in general, is preferably substantially equivalent to the anionic hydrophilic groups of the hydrophilic chain length regulator.

From the standpoint of improving the water dispersibility of the urethane prepolymer, a surface active agent may be appropriately used. Examples of the usable surface active agent are a nonionic surface active agent such as a higher alcohol ethylene oxide adduct (such as polyoxyethylene lauryl ether, polyoxyethylene cetyl ether, polyoxyethylene stearyl ether or polyoxyethylene oleyl ether), a higher alcohol propylene oxide adduct, a higher alcohol (ethylene oxide-propylene oxide) adduct, an alkylphenol ethylene oxide adduct (such as polyoxyethylene nonyl phenyl ether or polyoxyethylene octyl phenyl ether), an aryl phenol ethylene oxide adduct, a fatty acid ethylene oxide adduct, fatty acid polyethylene glycol ester, a fatty acid amide ethylene oxide adduct, a long-chain alkylamine ethylene oxide adduct, polyol fatty acid ester ethylene oxide adduct, an ethylene oxide adduct of fat and oil, glycerin fatty acid ester, polyglyceride, pentaerythritol fatty acid ester, sorbitol fatty acid ester (sorbitan ester), a sorbitan ester ethylene oxide adduct, saccharose fatty acid ester, alkyl ether of polyol or fatty acid amide of an alkanol amine; an anionic surface active agent such as alkyl ether sulfuric ester salt, alkylbenzene sulfonic acid salt or sulfosuccinic acid dialkyl ester salt; and a cationic surface active agent such as quaternary alkyl ammonium salt, and one of them or a mixture of two or more of them can be used. Among these examples, a nonionic surface active agent with an HLB value of 6 through 20 is preferred from the standpoint of improving the water dispersibility of the urethane prepolymer and efficiently performing a washing process described below.

The content of the surface active agent is preferably 0.1 through 20 wt %, more preferably 1 through 15 wt % and most preferably 3 through 15 wt % based on the urethane prepolymer.

In the present invention, 1,4-diaminobutane is used as a curing agent (crosslinking agent). In adopting the aforementioned preferable solid content concentration of the water-dispersed urethane prepolymer, if a polyamine compound other than the 1,4-diaminobutane (such as ethylenediamine, 1,6-hexamethylenediamine, 1,3-propanediamine, 1,2-propylenediamine, tetramethylenediamine or neopentyldiamine) is used as the curing agent to be mixed with the water-dispersed urethane prepolymer and injected into a die, faulty curing such that sufficient strength cannot be attained occurs. According to the examination made by the present inventors, however, the faulty curing can be avoided merely when the 1,4-diaminobutane is used.

The content of the 1,4-diaminobutane is preferably 10 through 90%, more preferably 15 through 50% and most preferably 20 through 40% in an equivalent ratio between the active isocyanate groups of the water-dispersed urethane prepolymer (the theoretical value obtained before the water dispersion) and active hydrogen groups of the 1,4-diaminobutane.

The cast molded article of this invention can be produced by any of the known methods, and the production method is not particularly specified. For example, the water-dispersed urethane prepolymer obtained as described above and the 1,4-diaminobutane are homogeneously mixed at room temperature (20 through 40° C.), the thus obtained mixture is injected into a die, the resultant is allowed to stand at 20 through 50° C. for 10 hours or more for promoting the crosslinkage, the thus obtained cured reactant is demolded, and moisture of the cured reactant is removed. In this invention, the mixture of the water-dispersed urethane prepolymer and the 1,4-diaminobutane is injected into the die preferably within two minutes after mixing them. When the mixture is injected into the die beyond this time, an injection failure may occur. Also, the material for the die used in molding is not particularly specified but may be silicone, Teflon (registered trademark), a metal or the like.

In the aforementioned production method, the step of mixing the water-dispersed urethane prepolymer and the 1,4-diaminobutane and injecting the mixture into the die for the crosslinkage preferably has a sub-step of applying a pressure after injecting the mixture into the die in order to attain high surface accuracy of the molded article by reducing the sizes of bubbles formed during the crosslinkage. The timing and the time for applying the pressure are not particularly specified, and in general, the pressure is applied immediately after injecting the mixture into the die (that is, from the initial stage of the crosslinkage) continuously for several hours. Specifically, the die into which the mixture has been injected is placed in a pressure tank used for general pressure molding to be provided with a pressure of approximately 1 through 5 kgf/cm².

The cast molded article of this invention may include, apart from the aforementioned neutralizing agent and the surface active agent, an additive such as a coloring agent, an anti-fungus agent, an antioxidant, a UV absorber, a light stabilizer, an anti-foam agent, a thickening agent, a pH adjuster, a deodorant or a mildewproof agent as an arbitrary component, and one of them or a mixture of two or more of them can be used. In this invention, there is no need to use, as an arbitrary component, a low profile additive or a mold releasing agent generally used in production of polyurethane.

In the case where the water-dispersed urethane prepolymer including an anionic chain length regulator as a constituent component of the hydrophilic chain length regulator includes a neutralizing agent, a compound reactive with anionic hydrophilic groups of the anionic chain length regulator may be additionally used in the crosslinkage of the urethane prepolymer from the standpoint of suppressing degradation of the polyurethane porous substance to be obtained. Examples of such a compound are a carbodiimide compound, an oxazoline compound, an epoxy compound and a melamine compound. Furthermore, when the compound is included, the neutralizing agent forming a salt with the anionic hydrophilic groups is dissociated from the anionic chain length regulator, and therefore, the washing process described below can be efficiently performed.

In the production of the cast molded article, the terminal isocyanate group of the urethane prepolymer included in the water-dispersed urethane prepolymer reacts with the water existing around it, and therefore, the urethane prepolymer is allowed to react with the 1,4-diaminobutane preferably within 48 hours after the dispersion in the water.

As a method for removing the moisture, air drying at room temperature may be adopted, but in general, a hot air dryer or the like is used for drying at 70° C. or more in order to reduce the time taken on removing the moisture. In the case where the resultant cured reactant includes a neutralizing agent, a surface active agent, an anti-foam agent, a thickening agent, a pH adjuster or the like, such a component is preferably washed with, for example, a washing machine or the like before the drying process.

In the aforementioned production method, even when a molded article with a fine structure is to be produced, a cured reactant can be easily demolded without causing faulty curing. Furthermore, the thus obtained cast molded article has a fine structure with high dimensional accuracy.

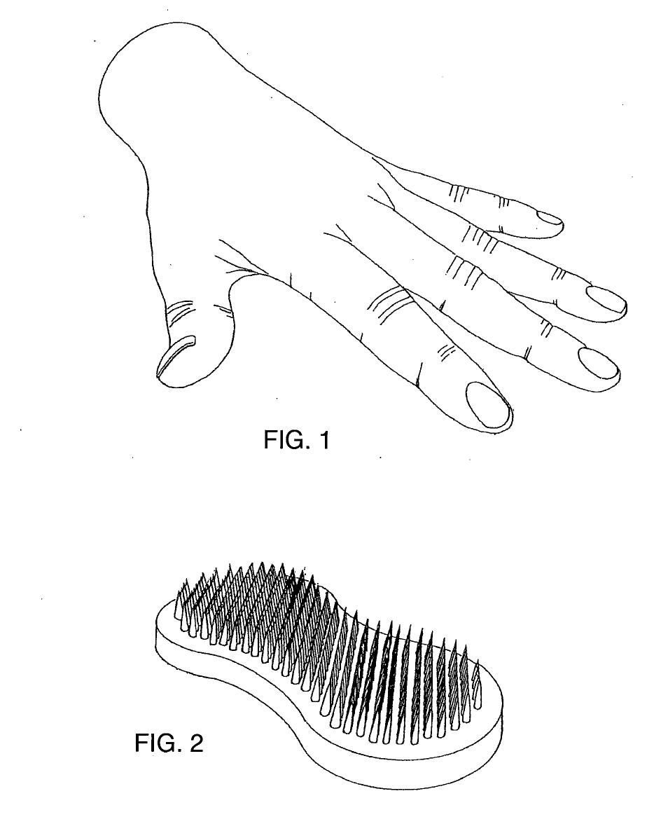

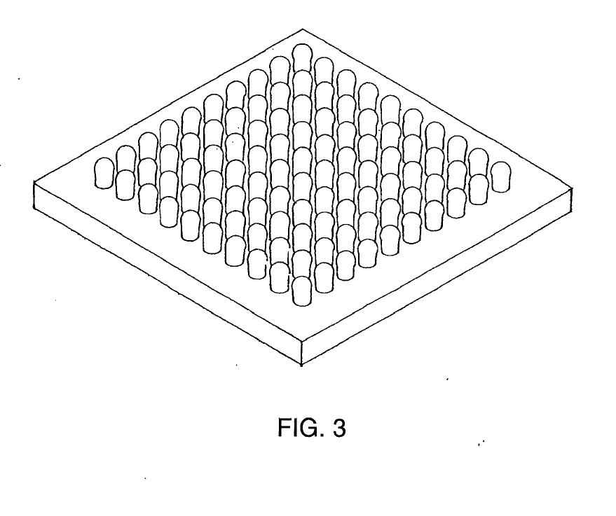

The molded article of this invention is applicable as a molded article in any of various shapes, and can be suitably used for any of various products with a fine structure such as a human hand as shown in FIG. 1, a brush shown in FIG. 2 and a foot massage tool shown in FIG. 3. The molded article of this invention is suitable for, for example, an artificial limb related tool. In the description, the “artificial limb related tool” herein means the whole or a part of a general artificial limb (artificial arm or artificial leg) or an artificial article to be worn on a lost part of a human body (such as an artificial finger, an artificial breast, an artificial ear or an artificial nose). When the molded article of this invention is used as an artificial limb related tool, it is possible to provide an artificial limb related tool that is light and breathable as compared with a silicone artificial limb related tool. In producing an artificial limb related tool, the aforementioned production method is adopted by using a die having a cavity corresponding to the structure of the artificial limb related tool to be produced (that is, a die for producing an artificial limb related tool).

### EXAMPLES

The present invention will now be described in more detail through examples, to which the invention is not limited.

### 1. Production Examples 1-4 of Molded Articles

### 1-1. Materials

Materials used in the production of each molded article were as follows:

(1) Polyol: polycarbonate polyol (manufactured by Nippon Polyurethane Industry Co., Ltd., trade name “Nippollan N-965”, having a molecular weight of 1,000)

(2) Chain length regulator: Ethylene glycol

(3) Isocyanate: 1,6-hexamethylene diisocyanate

(4) Hydrophilic chain length regulator: 2,2-dimethylolpropionic acid

(5) Neutralizing agent: triethylamine

(6) Surface active agent: manufactured by Sanyo Chemical Industries, Ltd., trade name “Naroacty-N-140”, polyoxyalkylene alkyl ether type, having HLB of 14.7

(7) Antioxidant: manufactured by Sumitomo Chemical Co., Ltd., trade name “Sumilizer GA-80”

(8) Anti-foam agent: manufactured by Shin-etsu Chemical Co., Ltd., trade name “KS-538”

(9) Water

(10) Organic solvent: N,N′-dimethylformamide (DMF)

(11) Curing agent: 1,4-diaminobutane or ethylenediamine

### 1-2. Production Example 1

### Present Invention

N-965 (polyol), ethylene glycol (a chain length regulator), 1,6-hexamethylene diisocyanate (isocyanate), 2,2-dimethylolpropionic acid (a hydrophilic chain length regulator), triethylamine (a neutralizing agent), GA-80 (an antioxidant), and DMF (an organic solvent) were placed in a three-necked round flask in mixing ratios listed in Table 1, and the resultant was stirred at 80° C. for 3 hours, so as to obtain a urethane prepolymer.

At the same time, a solution in which water, N-140 (a surface active agent) and KS-538 (an anti-foam agent) were mixed in mixing ratios listed in Table 1 was prepared, and with a temperature kept at 35° C., the prepared urethane prepolymer was added to the solution and the resultant was stirred for 10 minutes, so as to obtain a water-dispersed urethane prepolymer.

To the water-dispersed urethane prepolymer thus obtained, 1,4-diaminobutane (a curing agent) was added in a mixing ratio listed in Table 1, the resultant was mixed at 35° C. for 10 seconds, the thus obtained mixture was injected into a silicone die (with a cavity dimension of 20 cm in length, 20 cm in width and 10 cm in height), and the resultant was allowed to stand at 40° C. for 16 hours for crosslinkage. The thus obtained cured reactant was demolded, washed with a washing machine and ultimately dried at 100° C. for 6 hours, resulting in obtaining a cast molded article.

### 1-3. Production Examples 2-4

### Comparison Examples 1-3

Each cast molded article was produced in the same manner as in Production Example 1 except that ethylenediamine was used as the curing agent instead of the 1,4-diaminobutane and that the mixing ratios of water and the curing agent were changed as listed in Table 1.

TABLE 1

| | | | | | Production | Production | Production |
|---|---|---|---|---|---|---|---|
| | | | | Production | Example 2 | Example 3 | Example 4 |
| | | | Essential | Example 1 | (Comparison | (Comparison | (Comparison |
| Name of Component | | | Component | (invention) | Example 1) | Example 2) | Example 3) |
| Water- | Urethane | N-965 | polycarbonate | 509.27 | 509.27 | 509.27 | 509.27 |
| dispersed | prepolymer | | polyol | | | | |
| urethane | | ethylene glycol | Chain length | 7.59 | 7.59 | 7.59 | 7.59 |
| prepolymer | | | regulator | | | | |
| (parts by | | 2,2-dimethylol- | Hydrophilic | 10.5 | 10.5 | 10.5 | 10.5 |
| weight) | | propionic acid | chain length | | | | |
| | | | regulator | | | | |
| | | 1,6-hexamethylene | Isocyanate | 164.73 | 164.73 | 164.73 | 164.73 |
| | | diisocyanate | | | | | |

| | | | | | | |
|---|---|---|---|---|---|---|
| | N-140 | Surface | 66.4 | 66.4 | 66.4 | 66.4 |
| | | active agent | | | | |
| | triethylamine | Neutralizing | 7.91 | 7.91 | 7.91 | 7.91 |
| | | agent | | | | |
| | GA-80 | Antioxidant | 2.8 | 2.8 | 2.8 | 2.8 |
| | KS-538 | Anti-foam | 0.94 | 0.94 | 0.94 | 0.94 |
| | | agent | | | | |
| | water | — | 1108.4 | 1106.0 | 1109.0 | 1113.0 |
| | DMF | Organic solvent | 34.6 | 34.6 | 34.6 | 34.6 |
| Curing | 1,4-diaminobutane | Curing agent | 7.33 | — | — | — |
| | ethylenediamine | Curing agent | — | 5.00 | 8.00 | 12.00 |

### 1-4. Evaluation

### Demolding Properties

Easiness in demolding each cured reactant (demolding properties) and the appearance of the cured reactant obtained after demolding were evaluated.

### Degree of Shrinkage

The length, the width and the height of each cured reactant obtained after demolding were measured so as to calculate a degree of shrinkage on the basis of reference values (i.e., the length of 20 cm, the width of 20 cm and the height of 10 cm).

### 1-5. Results

### Demolding Properties

The cured reactant of Production Example 1 (present invention) had low resistance in demolding and was easily demolded. The cured reactant obtained after demolding was in a square shape in a plan view and was in a rectangular parallelepiped shape as a whole, and was neither broken nor cracked at all during demolding.

On the other hand, a cured reactant of each of Production Examples 2 through 4 (Comparison Examples 1 through 3) had high resistance in demolding, and when it was forced to be demolded, it was demolded with a part thereof adhered within the die and was mostly broken when demolded.

It is understood, from the results described above, that the cured reactant of Production Example 1 is good at the demolding properties and that the cured reactants of Production Examples 2 through 4 (Comparison Examples 1 through 3) were poor at the demolding properties.

### Degree of Shrinkage

The degree of shrinkage of the cured reactant of Production Example 1 (present invention) was 0.67% in the length and width (as an average of the length and the width) and 0.39% in the height. On the other hand, the cured reactants of Production Examples 2 through 4 (Comparison Examples 1 through 3) were in the form of a pudding and hence the degree of shrinkage could not be measured.

It is understood, from the results described above, that the degree of shrinkage of the cured reactant of Production Example 1 was less than 1% and was evaluated to be small, but the degree of shrinkage of the cured reactants of Production Examples 2 through 4 (Comparison Examples 1 through 3) could not be evaluated because of the faulty curing.

### 2. Production Examples 5-7 of Molded Articles

### Present Invention

Each cast molded article was produced in the same manner as in Production Example 1 except that a die with a cavity having a structure of a human hand, a brush or a foot massage tool was used (see FIGS. 1 through 3). All of the thus obtained molded articles were good at the demolding properties in the production and had structures reproducing fine cavity structures with fidelity. Specifically, the molded article in the shape of a human hand shown in FIG. 1 had a structure obtained by reproducing the fine structure of the cavity with fidelity even with respect to fingerprints, the molded article in the shape of a brush shown in FIG. 2 had a large number of conical brush portions with a small diameter provided on a base obtained by reproducing the fine structure of the cavity with fidelity, and the molded article in the shape of a foot massage tool shown in FIG. 3 had a large number of substantially cylindrical foot massage portions provided on a base obtained by reproducing the fine structure of the cavity with fidelity. It is understood from these results that there is no need to use a low profile additive or a mold releasing agent even in producing a molded article with a fine structure by adopting the production method of this invention.

### INDUSTRIAL APPLICABILITY

The present invention is applicable to a variety of cast molded articles having fine structures and a method for producing the same, and is applicable to various products including, for example, a human hand shown in FIG. 1, a brush shown in FIG. 2 and a foot massage tool shown in FIG. 3.

1. A cast molded article made of a polyurethane porous substance obtained by removing moisture from a cured reactant resulting from crosslinking a water-dispersed urethane prepolymer, having a 30 through 70 wt % solid content concentration, and having a terminal isocyanate group, which is obtained by reacting polyol, a chain length regulator, isocyanate and 0.1 through 4 wt % of a hydrophilic chain length regulator to one another, with 1,4-diaminobutane within a die.

2. An artificial limb related tool made of the polyurethane porous substance of claim 1.

3. A method for producing a cast molded article made of a polyurethane porous substance comprising the steps of:
reacting polyol, a chain length regulator, isocyanate and 0.1 through 4 wt % of a hydrophilic chain length regulator to one another, whereby obtaining a urethane prepolymer having a terminal isocyanate group;
allowing the urethane prepolymer having a terminal isocyanate group to be mixed with and dispersed in water, whereby obtaining a water-dispersed urethane prepolymer, having a 30 through 70 wt % solid content concentration;
mixing the water-dispersed urethane prepolymer with 1,4-diaminobutane and injecting a resultant mixture into a die for crosslinkage, whereby obtaining a cured reactant; and
demolding the cured reactant and removing moisture from the cured reactant.

4. The method for producing a cast molded article of claim 3, wherein the step of mixing the water-dispersed urethane prepolymer with 1,4-diaminobutane and injecting a resultant mixture into a die for crosslinkage includes a sub-step of applying a pressure after injecting the mixture into the die.

5. The method for producing a cast molded article of claim 3 or 4, wherein the die is a die for producing an artificial limb related tool.
